(19) United States
(12) Patent Application Publication
(10) Pub. No.: US 2022/0087232 A1
(43) Pub. Date: Mar. 24, 2022

(54) FISH ATTRACTING SYSTEMS AND METHODS

(71) Applicant: TH Products, LLC, San Antonio, TX (US)

(72) Inventors: Chris Blood, San Antonio, TX (US); Brett Jarriel, Aiken, SC (US); Bart Stephens, Birmingham, AL (US); Will Goering, Sparks, MD (US)

(73) Assignee: TH Products, LLC, San Antonio, TX (US)

(21) Appl. No.: 17/479,213

(22) Filed: Sep. 20, 2021

Related U.S. Application Data
(60) Provisional application No. 63/081,093, filed on Sep. 21, 2020.
(60) Provisional application No. 63/111,405, filed on Nov. 9, 2020.

(51) Int. Cl. A01K 61/78

(52) U.S. Cl. CPC A01K 61/78

(57) ABSTRACT

The present disclosure provides fish attracting systems and habitats. The fish attracting systems are designed to mimic sunken grass-like vegetation that will move and wave like other aquatic vegetation, for example, hydrilla or milfoil, in order to attract fish, provide a hiding place for fish, serve as a location for fish to attach their eggs and provide a food source for the fish. The fish attracting systems are also designed to mimic one or more lily pads that are buoyant and are designed to float, creating shade underneath.

### CROSS-REFERENCE TO RELATED APPLICATIONS

This application claims the benefit of and priority to U.S. Provisional Application No. 63/081,093, filed on Sep. 21, 2020, and entitled “Fish Attracting Systems and Methods,” and U.S. Provisional Application No. 63/111,405, filed on Nov. 9, 2020, and entitled “Artificial Fish Attractor, Escape Habitat, and Fish Feeder Systems and Methods,” the disclosures of which are expressly incorporated by reference in its entirety.

### TECHNICAL FIELD

The present invention relates generally to the field of fish attracting systems and methods. The systems disclosed herein can act as fish habitats and also facilitate spawning.

### BACKGROUND

It is widely known that fish are often attracted to or congregate around various structures. For example, fish and other aquatic animals use the structures for protection, shade, to feed on other fish or prey attracted to the structures, to lay eggs, and for other purposes. Such structures may include aquatic vegetation, for example, hydrilla, milfoil, or lily pads, or timber or brush piles. In hopes of attracting fish, some fisherman will create and place their own structures, including sinking Christmas trees, brush piles, or other structures, in areas where they plan to fish. However, these structures often deteriorate, or end up being moved from their original location due to currents or water movements. Accordingly, there remains a need in the art for improved systems and methods for attracting fish to increase fishermen's chances of catching fish.

### SUMMARY

The problems expounded above, as well as others, are addressed by the following inventions, although it is to be understood that not every embodiment of the inventions described herein will address each of the problems described above. The present disclosure describes different embodiments of certain artificial fish attracting systems and habitats.

In a first aspect, a fish attracting system is provided, the fish attracting system including a platform having a surface with a first hole formed therein, an artificial vegetation attachment including a base and a plurality of vegetation strands attached to the base, wherein the base includes a second hole corresponding to the first hole and configured for receiving a fastener to secure the artificial vegetation attachment to the platform, and wherein the vegetation strands are formed of polyethylene film.

In a second aspect, a fish attracting system is provided, the fish attracting system including a platform having a surface with a first hole formed along a perimeter of the platform and a second hole formed on an interior portion of the platform, a first artificial vegetation attachment including a first plurality of vegetation strands, a second artificial vegetation attachment including a second plurality of vegetation strands, wherein the first plurality of vegetation strands includes a greater number of vegetation strands than the second plurality of vegetation strands and the first plurality is configured for attachment at the first hole and the second plurality is configured for attachment at the second hole.

In a third aspect, a kit for a fish attracting system, the kit including a platform having a surface comprising a plurality of holes configured for receiving a fastener and a plurality of slots for receiving a securing strap, an artificial vegetation attachment configured for attachment to the platform, wherein the artificial vegetation attachment includes a base and a plurality of vegetation strands integrally formed with the base, a plurality of fasteners configured for attaching the base of the artificial vegetation attachment to the platform, and a plurality of securing straps configured for attaching a weight to the platform.

### BRIEF DESCRIPTION OF THE DRAWINGS

Further features and advantages can be ascertained from the following detailed description that is provided in connection with the drawings described below:

FIG. 1 is a perspective view of a fish attracting device according to an embodiment of the present disclosure.

FIG. 2A is a perspective view of an artificial vegetation attachment as viewed in an aquatic environment according to an embodiment of the present disclosure.

FIG. 2B is a perspective view of the artificial vegetation attachment as viewed in an aquatic environment according to another embodiment of the present disclosure.

FIG. 3A is a perspective view of the artificial vegetation attachment as viewed in an aquatic environment according to still another embodiment of the present disclosure.

FIG. 3B is a perspective view of the artificial vegetation attachment as viewed in an aquatic environment according to yet another embodiment of the present disclosure.

FIG. 4A is a perspective view of the artificial vegetation attachment as viewed in an aquatic environment according to another embodiment of the present disclosure.

FIG. 4B is a perspective view of the artificial vegetation attachment according to still another embodiment of the present disclosure.

FIG. 5A is a perspective view of a platform for use with the fish attracting device according to one embodiment of the present disclosure.

FIG. 5B is a perspective view of an exemplary fastener for securing the artificial vegetation attachment to the platform according to one embodiment of the present disclosure.

FIG. 6 is a bottom view of the platform shown in FIG. 5.

FIG. 7 is a perspective view of the platform for use with the fish attracting device according to another embodiment of the present disclosure.

FIG. 8A is a perspective view showing a weight attached to the platform according to one embodiment of the present disclosure with the artificial vegetation attachments as viewed in an aquatic environment.

FIG. 8B is a perspective view showing the weight attached to the platform according to another embodiment of the present disclosure with the artificial vegetation attachments as viewed in an aquatic environment.

FIG. 8C is a perspective view showing the weight attached to the platform according to still another embodiment of the present disclosure with the artificial vegetation attachments as viewed in an aquatic environment.

FIG. 9A is a bottom view of the platform shown in FIG. 5A with straps attached thereto according to one embodiment of the present disclosure.

FIG. 9B is a bottom view of the platform shown in FIG. 5A with the straps and the weight attached thereto according to one embodiment of the present disclosure.

FIG. 10 is a perspective view showing the weight attached to the platform according to another embodiment of the present disclosure with the artificial vegetation attachments as viewed in an aquatic environment.

FIG. 11 is a perspective view of the fish attracting system showing the platform filled with artificial vegetation attachments according to one embodiment of the present disclosure.

FIG. 12 is a perspective view of the fish attracting system showing the platform partially filled with artificial vegetation attachments according to another embodiment of the present disclosure.

FIG. 13 is a perspective view of the fish attracting system showing the platform partially filled with artificial vegetation attachments according to still another embodiment of the present disclosure.

FIG. 14 is a perspective view of the fish attracting system deployed in a body of water according to an embodiment of the present disclosure.

FIG. 15A is a perspective view of an artificial lily pad according to one embodiment of the present disclosure.

FIG. 15B is a top view of the artificial lily pad of FIG. 15A.

FIG. 15C is a bottom view of the artificial lily pad of FIG. 15A.

FIG. 15D is a front view of the artificial lily pad of FIG. 15A.

FIG. 15E is a rear view of the artificial lily pad of FIG. 15A.

FIG. 15F is a first side view of the artificial lily pad of FIG. 15A.

FIG. 15G is a second side view of the artificial lily pad of FIG. 15A.

FIG. 15H is a lower perspective view of the artificial lily pad of FIG. 15A.

FIG. 15I is a perspective view of the artificial lily pad according to another embodiment of the present disclosure.

FIG. 15J is a perspective view of the artificial lily pad according to still another embodiment of the present disclosure.

FIG. 16 is a perspective view of a cluster of artificial lily pads according to one embodiment of the present disclosure.

FIG. 17 is a perspective view of the cluster of artificial lily pads floating and anchored in the body of water.

FIG. 18 is a perspective view of an attachment mechanism for anchoring the cluster of artificial lily pads.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first,” “second,” “third,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Spatially relative terms, such as “above,” “under,” “below,” “lower,” “over,” “upper,” and the like, may be used herein for ease of description to describe one element or feature's relationship to another when the apparatus is right side up as shown in the accompanying drawings.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

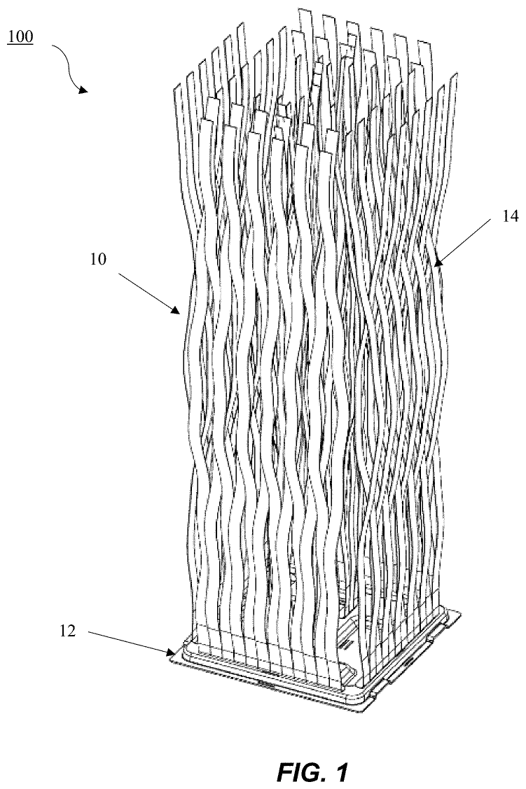

Referring to FIG. 1, a fish attracting system 100 according to an exemplary embodiment of the present disclosure is shown. The fish attracting system 100 includes a plurality of artificial vegetation attachments 10 secured to a platform 12. The artificial vegetation attachments 10 are composed of vegetation strands 14 that are designed to simulate aquatic plants, like grass, hydrilla, milfoil, or seaweed, to attract fish, provide a hiding place for fish, and serve as a location for fish to attach their eggs. The fish attracting system 100 can be deployed in any body of water, including, for example, in ponds, lakes, rivers, marshes, swamps, and the ocean.

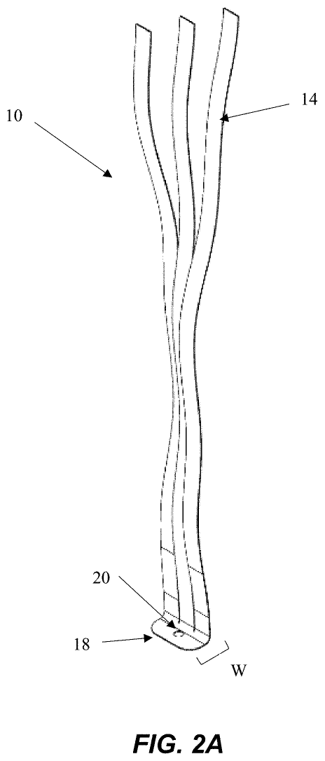

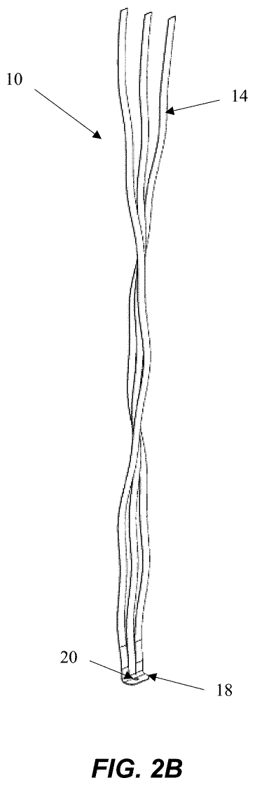

FIGS. 2A-2B, 3A-3B, and 4 show various embodiments of the artificial vegetation attachments 10 that can be attached and secured to the platform 12. The vegetation strands 14 of the artificial vegetation attachments 10 are preferably straight but will move and wave with the water currents. FIGS. 2A-2B, 3A-3B, and 4 show the vegetation strands 14 as they might look in an aquatic environment, moving and waving with various water currents. The artificial vegetation attachments 10 are configured to be secured to the platform 12. As will be discussed in more detail below, the artificial vegetation attachments 10 are placed around the perimeter of the platform 12, or in any other configuration desired by a user, to create an area inside for fish to swim, feed, spawn, and/or hide from predators.

FIGS. 2A and 2B show one embodiment of the artificial vegetation attachments 10. In this embodiment, the artificial vegetation attachments 10 include three vegetation strands 14 attached to a base 18. The base 18 includes a hole 20 configured to receive an attachment mechanism, such as a fastener, to secure the vegetation strands 14 to the platform 12. The width of the base W may vary so long as the base width W is wide enough to securely attach the artificial vegetation attachments 10 to the platform 12. In some embodiments, the base width W is about ¼ inch to about 3 inches. In another embodiment, the base width W is about ½ inch to about 2 inches. In these embodiments, the base width W may be added to the lengths of the vegetation strands 14 themselves.

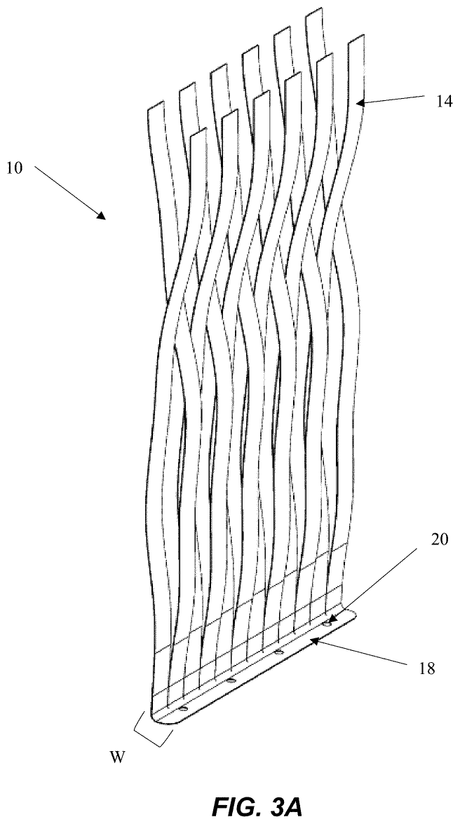

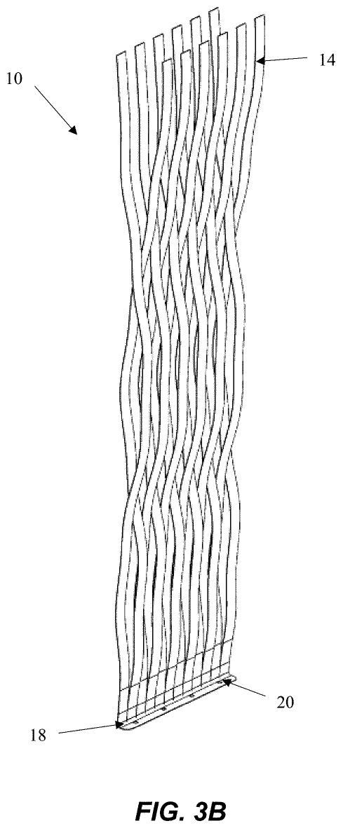

FIGS. 3A and 3B show another embodiment of the artificial vegetation attachments 10. In the illustrated embodiment, the artificial vegetation attachments 10 include twelve vegetation strands 14 attached to the base 18. The base 18 includes four holes 20 configured to receive an attachment mechanism to secure the vegetation strands 14 to the platform 12. The base 18 may have any base width W discussed above that allows for the artificial vegetation attachments 10 to be secured to the platform 12. While the embodiments shown in FIGS. 2A-2B and 3A-3B include three and twelve vegetation strands, respectively, it will be appreciated by those of ordinary skill in the art that the artificial vegetation attachments 10 described herein are customizable and may have any number of vegetation strands depending on the length of the platform 12 utilized and the desired visual effect.

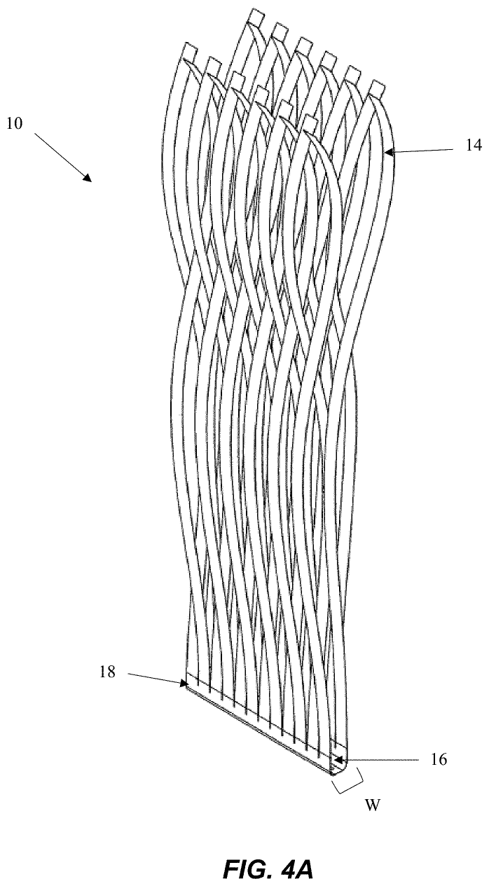

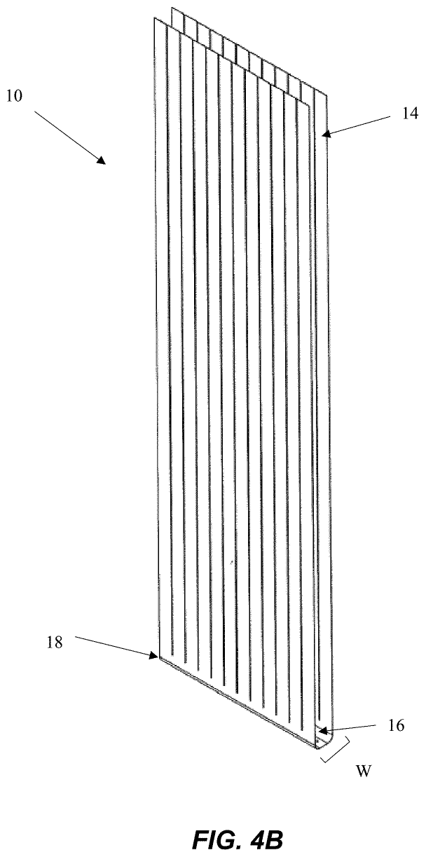

FIGS. 4A and 4B show yet another embodiment of the artificial vegetation attachments 10. FIG. 4A shows the vegetation strands 14 as they may look in the natural aquatic environment, while FIG. 4B shows the vegetation strands 14 in their straight form. It should be noted that the vegetation strands 14 are preferably not resilient and stiff enough to stand straight up outside of the water, but are depicted in a straight, vertical fashion to depict shape. In the illustrated embodiment of FIGS. 4A and 4B, the artificial vegetation attachment 10 includes two rows of twelve individual vegetation strands 14 such that there are twenty-four total vegetation strands 14. As shown in FIGS. 4A and 4B, the artificial vegetation attachments 10 are configured to be folded into a “U” shape, creating two rows of vegetation strands 14 and a channel 16 at the bottom of the “U” shape which can be secured to the platform 12. The channel 16 at the bottom of the “U” shape may have any base width W discussed above that allows for the artificial vegetation attachments 10 to be secured to the platform 12. For instance, the channel 16 may have a width of about ¼ inch to about 1 inch.

The vegetation strands 14 may have any shape that mimics the natural figure of aquatic vegetation, such as grass, seaweed, hydrilla, or milfoil. In the illustrated embodiment, the vegetation strands 14 are rectangular. However, the vegetation strands 14 may also be cylindrical, triangular, or include curved edges. For example, the vegetation strands may be shaped as grass blades or any other shape to simulate other weed configurations. In one embodiment, the vegetation strands 14 have a color, such as green or brown, that corresponds to the color of natural vegetation found in the body of water in which the system 100 is intended to be used.

The vegetation strands 14 can be made of any suitable material that is resilient, does not easily degrade in water, and is buoyant such that the vegetation strands 14 stand up when placed in the water and do not sink. In one embodiment, the vegetation strands 14 are made of a polymeric material. For example, the vegetation strands 14 may be made of polyethylene. In some embodiments, the vegetation strands 14 have a specific gravity of 1.0 or less so that when the vegetation strands 14 are placed in a body of water, the vegetation strands 14 tend to float and are naturally buoyant so as to appear like natural vegetation. For instance, the vegetation strands 14 may have a specific gravity of about 0.88 to about 0.92.

The vegetation strands 14 are preferably thin enough to enable the vegetation strands 14 to flutter and move with the water and water currents. In one embodiment, the vegetation strands 14 have a thickness of about 0.01 inches to about 0.07 inches. In another embodiment, the vegetation strands 14 have a thickness of about 0.02 inches to about 0.04 inches. In still another embodiment, the vegetation strands 14 have a thickness of about 0.02 inches to about 0.025 inches. For example, the vegetation strands 14 may have a thickness of about 0.023 inches.

The vegetation strands 14 may have any dimension that allows for the strands 14 to simulate aquatic vegetation. The vegetation strands 14 can be precut, as shown in FIGS. 2A-2B, 3A-3B, and 4. In other embodiments, the vegetation strands 14 may remain in effectively one piece so that a user may cut the width of the individual vegetation strands 14 as desired. In other embodiments, the artificial vegetation attachments 10 may have perforated predesigned “strands” that allow a user to “tear” or separate into as many strands as desired by the user. In some embodiments, the vegetation strands 14 have a width ranging from about 1 inch to about 36 inches. In another embodiment, the vegetation strands 14 may have a width ranging from about 10 inches to about 20 inches. In still another embodiment, the vegetation strands 14 may have a width ranging from about 12 inches to about 15 inches. For example, the vegetation strands 14 may be about 13.25 inches wide. In some embodiments, like that shown in FIGS. 2A-2B, some vegetation strands 14 may have a width between ½ inch and 3 inches.

In some embodiments, each vegetation strand 14 is between about 1 foot and 8 feet in length. In other embodiments, each vegetation strand 14 is between about 2.5 feet and 6 feet in length. In still other embodiments, each vegetation strand 14 is between about 3.5 feet and 5 feet in length. In a preferred embodiment, each vegetation strand 14 is about 4 feet in length. When the vegetation strands 14 are secured to the platform 12, the vegetation strands 14 may extend about 1 foot to about 8 feet above the platform 12. In other embodiments, the vegetation strands 14 may extend about 2 feet to about 6 feet above the platform 12. In still other embodiments, the vegetation strands 14 may extend about 4 feet above the platform 12. The vegetation strands 14 may be the same length, as generally shown in the figures. In other embodiments, the vegetation strands 14 may be of varying lengths. In still other embodiments, the vegetation strands 14 may not be cut along the entire length. For example, if the vegetation strands 14 are 4 feet in length, a user may elect to cut the vegetation strands 14 down only 2 feet, so that there is a “sheet” along the width for the first 2 feet in length, with the vegetation strands 14 for the other 2 feet.

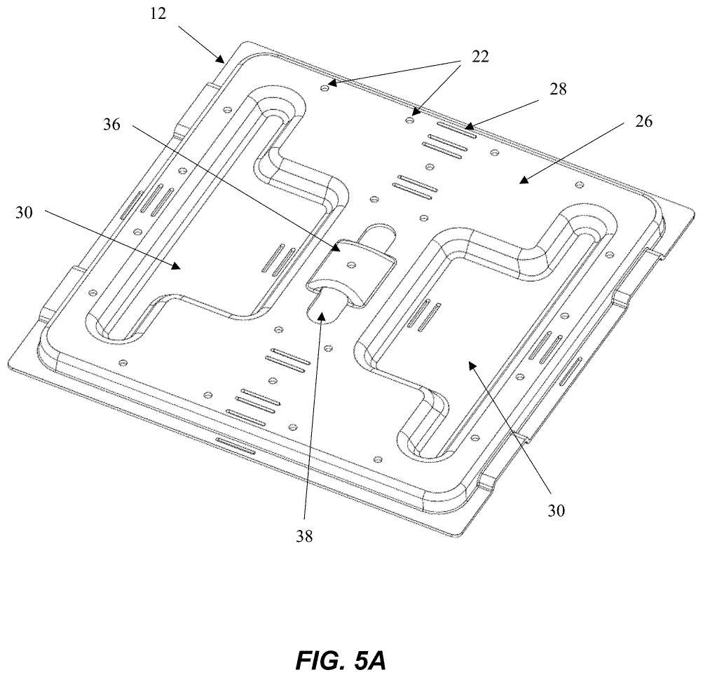

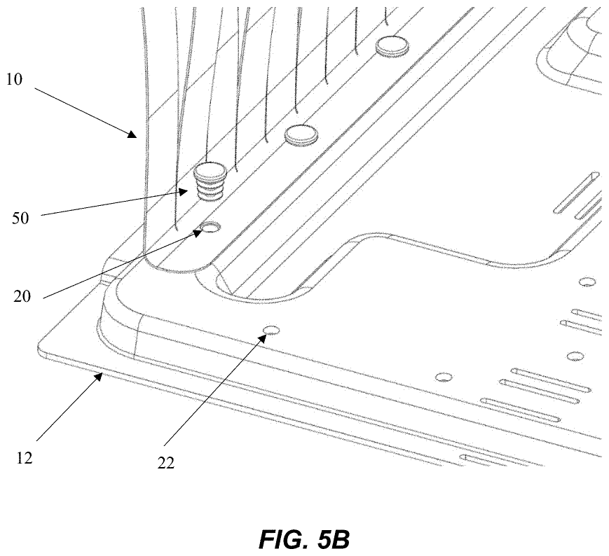

FIG. 5A shows the platform 12 to which the artificial vegetation attachments 10 can be secured according to one embodiment of the present disclosure. The platform 12 includes an upper surface 26 having a number of holes 22 used to secure the artificial vegetation attachments 10 to the platform 12. The holes 20 in the artificial vegetation attachments 10 preferably line up and correspond to the spacing of the holes 22 in the platform 12. In the illustrated embodiment, the holes 22 are positioned along the edges of the platform 12 and in various locations on the interior of the platform 12. As shown in FIG. 5A, four holes 22 are positioned along each edge of the platform 12 and six additional holes 22 are positioned toward the middle of the platform 12. The location of the holes 22 shown in FIG. 5A allows for the artificial vegetation attachments 10 to be positioned along the exterior and interior portions of the platform 12. However, as will be apparent to one of ordinary skill in the art, any number and configuration of holes 22 may be used on the platform 12 depending on the desired configuration of the artificial vegetation attachments 10.

The artificial vegetation attachments 10 may be secured to the platform 12 using an attachment mechanism, as shown in FIG. 5B. In some embodiments, the artificial vegetation attachments 10 can be secured to the platform 12 with friction fit pins or push pins. FIG. 5B shows an exemplary fastener 50 of the present disclosure. The fastener 50 includes flexible ridges along the length of the shaft to help hold it in place when it is secured to the platform 12. In other embodiments, the artificial vegetation attachments 10 can be secured to the platform 12 using straps, snaps, or other male/female connectors known to those in the industry. The artificial vegetation attachments 10 are preferably removably attached to the platform 12 such that if the vegetation strands 14 deteriorate or are torn, the artificial vegetation attachments 10 can be removed from the platform 12 and replaced with new artificial vegetation attachments. However, the artificial vegetation attachments 10 should be securely attached to the platform 12 during use so that the vegetation strands 14 are not dislodged by ordinary water movement and currents.

The platform 12 includes various slots 28 through the upper surface 26 that can be used to secure a weighted device to a bottom surface of the platform 12, as will be discussed in more detail below. In the illustrated embodiment, the slots 28 are positioned in a linear fashion on the interior of the platform 12 and along the perimeter of the platform 12. The slots 28 can be used in connection with a securing means to connect the platform 12 to the weighted device. In some embodiments, the slots 28 are positioned to approximate the edges of the weighted device secured to the platform 12. For example, if the weighted device has dimensions of 12 inches×12 inches, the slots 28 may be positioned 12 inches apart so that the securing strap fed through the slots 28 are positioned proximate to the edges of the weighted device. The slots 28 are shown as cylindrical openings, but any shape and size may be used so long as the slots 28 are able to receive the securing means to connect the platform 12 to the weighted device. In the illustrated embodiment, the platform 12 also includes an anchor point 36 in the center of the upper surface 26 with an oval shaped opening 38 formed thereunder. The securing means may be fed under the anchor point 36 (through the opening 38) and into one or more slots 28 to secure the weighted device to the platform 12. The anchor point 36 and/or the opening 38 can also be used to lower the system 100 into the water and in the desired position with rope, which can slide through and be removed from the system 100 when in the desired location.

The platform 12 also includes two indentations 30 within the upper surface 26. The indentations 30 provide a solid surface for the platform 12 when the weighted device (in some embodiments) is attached thereto. The indentations 30 also provide an area under the platform 12 to accommodate the attachment mechanisms of the artificial vegetation attachments 10 when they are inserted into the holes 22. In the illustrated embodiment, the indentations 30 are located on each half of the platform 12. However, any number of indentations 30 (or no indentations) may be used on the platform 12 so long as the indentations 30 do not interfere with the holes 22. The indentations 30 may also have any suitable shape that provides for a solid surface and allows sufficient clearance for the attachment mechanisms of the artificial vegetation attachments 10 to be inserted through the upper surface 26.

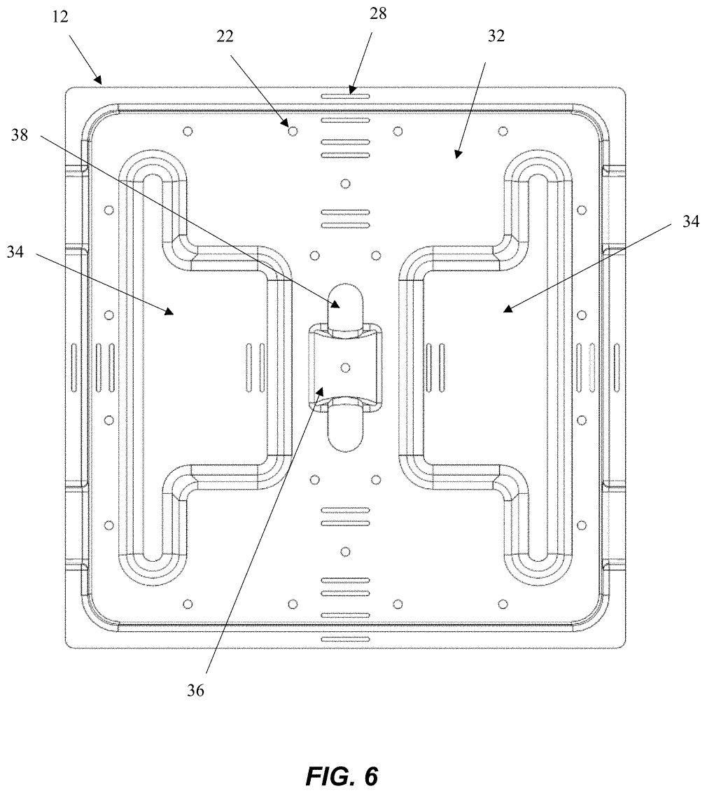

FIG. 6 shows a bottom view of the platform 12 illustrated in FIG. 5A. The platform 12 has a bottom surface 32 with the holes 22 and the slots 28 extending therethrough. The indentions 30 are shown having flat, bottom surfaces 34, which provide sufficient clearance for the attachment mechanisms to be inserted through the holes 22. In some embodiments, the weighted device is positioned in between the indentations 30 such that weighted device is placed under the anchor point 36 so that the weighted device can be secured with the securing means.

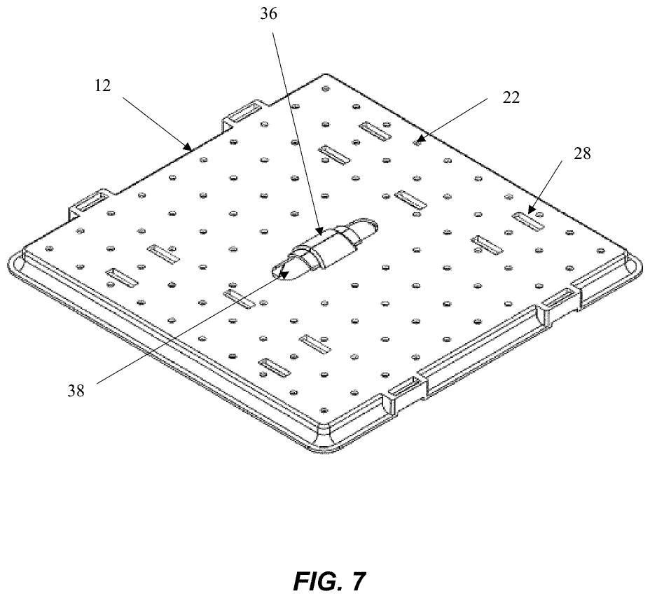

FIG. 7 shows the platform 12 to which the artificial vegetation attachments 10 can be secured according to another embodiment of the present disclosure. Like the embodiment shown in FIGS. 5 and 6, the illustrated embodiment of FIG. 7 includes the holes 22 used to secure the artificial vegetation attachments 10 to the platform 12. The holes 22 are arranged in a linear fashion along the upper surface 26. The platform 12 also includes the slots 28 that can be used to secure a weighted device to the bottom surface of the platform 12. In the illustrated embodiment, there are ten slots 28 on the interior of the platform 12 and four slots 28 on the perimeter of the platform 12. The platform 12 also includes the anchor point 36 in the center of the upper surface 26 with the oval-shaped opening 38 formed thereunder.

In some embodiments, the platform 12 may be made of a thermoplastic polymeric material. Suitable thermoplastic polymeric materials include, but are not limited to, nylon (polyamide), acrylic, polycarbonate, polyoxymethylene (POM), polystyrene (PS), acrylonitrile butadiene styrene (ABS), polypropylene (PP), polyethylene (PE), and high-density polyethylene (HDPE). In one embodiment, the platform 12 may be made of polypropylene. In another embodiment, the platform 12 may be made of acrylonitrile butadiene styrene (ABS). For example, the platform 12 may be made of recyclable ABS, which is eco-friendly. In some embodiments, the platform 12 may have a specific gravity greater than 1.0 such that the platform 12 itself is able to sink within the body of water. For example, the platform 12 may have a specific gravity of 1.04, which enables it to sink within the water. In other embodiments, when the platform 12 is attached to the weighted device, the platform 12 may have a specific gravity of less than 1. In some embodiments, the platform 12 is vacuum formed (thermoformed). In other embodiments, the platform 12 may be injection molded.

In some embodiments, the platform 12 may be made of a cast metal, such as aluminum, magnesium, copper, tin, zinc, lead, iron or steel, ceramic, or other weighted materials such that the platform 12 itself is weighted, so that it can sink within the body of water without the use of the weighted device. In this embodiment, the platform 12 should have a sufficient weight to sink within the body of water. For example, the platform 12 should weigh at least 5 pounds or greater. In other embodiments, the platform 12 should weigh at least 10 pounds or greater. In still other embodiments, the platform 12 may weigh over 15 pounds.

In some embodiments, the upper surface 26 of the platform 12 has a textured finish. It is believed the rough texture promotes the growth of algae on the fish attracting system 100, which helps to attract the fish and can serve as a food source to fish and other living creatures. In one embodiment, the upper surface 26 has a haircell textured finish. However, any other textured finishes may be applied to the upper surface 26.

The platform 12 may have any shape and size suitable to allow for the fish attracting system 100 to be deployed and used in the water. In the illustrated embodiment, the platform 12 is shaped as a square. However, other suitable shapes for the platform 12 include rectangular, circular, oval, and diamond shaped. In some embodiments, the platform 12 has curved edges designed to help prevent snags from fishing lures. The platform 12 may have a length and/or width ranging from about 8 inches to about 30 inches. In some embodiments, the length and/or width of the platform 12 may range from about 12 inches to about 24 inches. In other embodiments, the length and/or width of the platform 12 may range from about 12 inches to about 18 inches. In still other embodiments, the length and/or width of the platform 12 may range from about 16 inches to about 18 inches. For example, the platform 12 may have dimensions of about 12 inches by 12 inches, 16 inches by 16 inches, 18 inches by 18 inches, or 16 inches by 24 inches. The height of the platform 12 can also vary. In some embodiments, the height of the platform 12 is between about 0.5 inches and 2 inches. In other embodiments, the height of the platform 12 is between about 0.6 inches and 1 inch. In a preferred embodiment, the height of the platform is about 0.75 inches. The platform 12 may have a thickness ranging from about 0.05 inches to about 0.25 inches. In a preferred embodiment, the platform 12 has a thickness of about 0.125 inches.

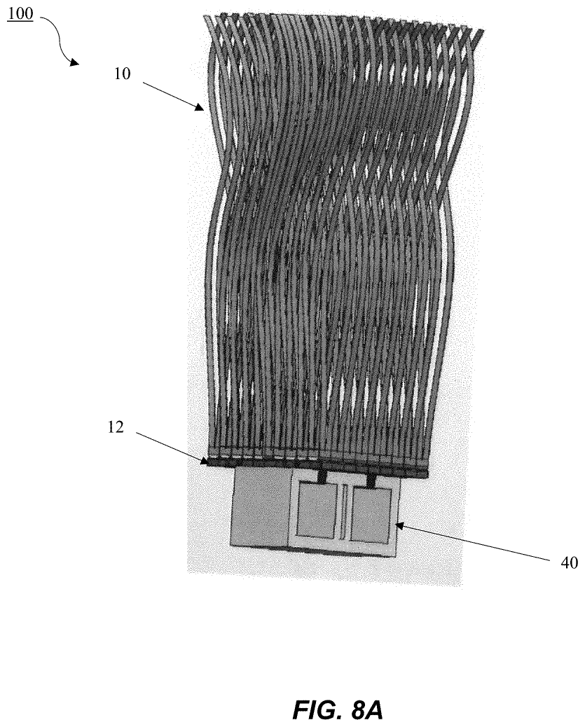

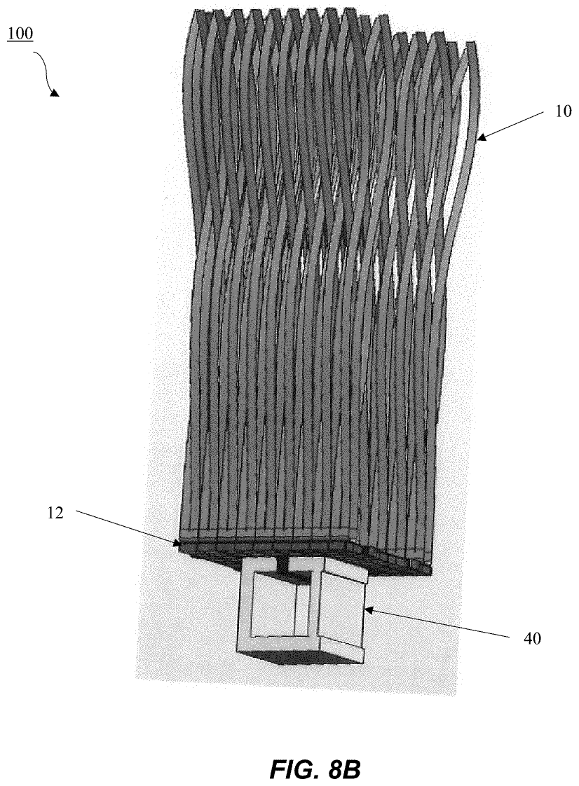

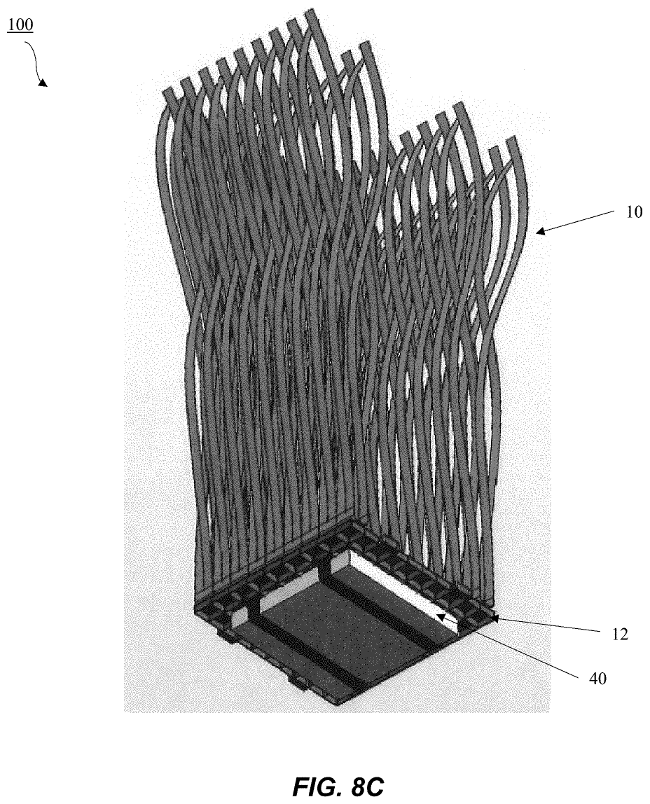

FIGS. 8A-8C show various embodiments of the platform 12 having the artificial vegetation attachments 10 attached thereto and secured to a weighted device 40. The weighted device 40 allows for the fish attracting system 100 to be deployed into the body of water and placed in a particular location chosen by the user. The weighted device 40 may be any type of weight sufficient to allow the fish attracting system 100 to sink within the water. For example, as shown in FIG. 8A, the weighted device 40 may be a cinder block. In another embodiment, as shown in FIG. 8B, the weighted device 40 may be a half cinder block. In still another embodiment, as shown in FIG. 8C, the weighted device 40 may be a paver, for example, an 8-inch paver, a 12-inch paver, or a 16-inch paver.

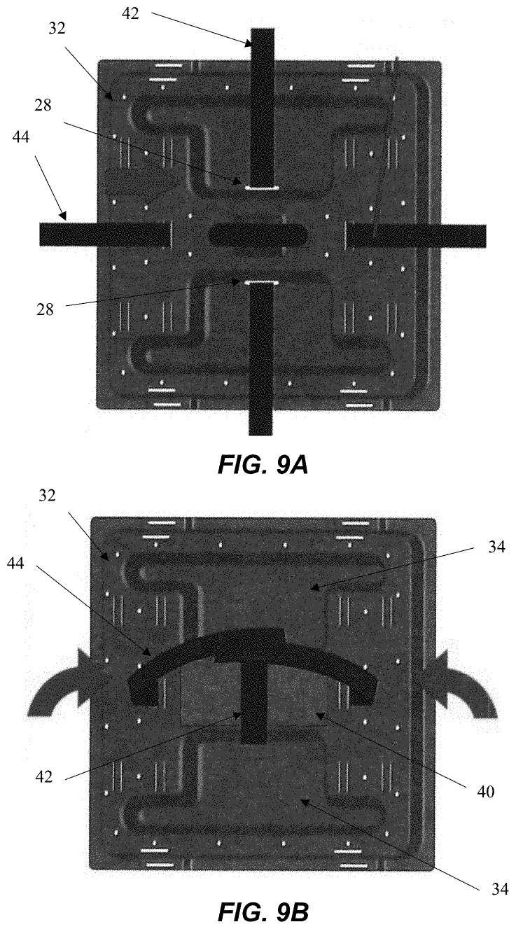

FIGS. 9A and 9B show how the weighted device 40 may be secured to the platform 12 according to one embodiment of the present disclosure. FIG. 9A shows the bottom surface 32 of the platform 12. A first securing strap 42 is inserted through slots 48 in a longitudinal direction such that the first securing strap 42 loops over the anchor point 36 on the upper surface 26. A second securing strap 44 is inserted through slots 48 in a transverse direction such that the second securing strap 44 is inserted through opening 38 formed under the anchor point 36. As shown in FIG. 9B, the weighted device 40 (for example, a brick or similar dimensioned paver) can be placed in the center of the platform 12 (in between the indentations 30) and the first and second securing straps 42, 44 can be folded over the weighted device 40 to overlap and secure the weighted device 40. In this embodiment, the first and second securing straps 42, 44 may be hook and loop fasteners, such as Velcro® straps. In other embodiments, the first and second securing straps 42, 44 may formed of heavy-duty rope, string, cord, or twine.

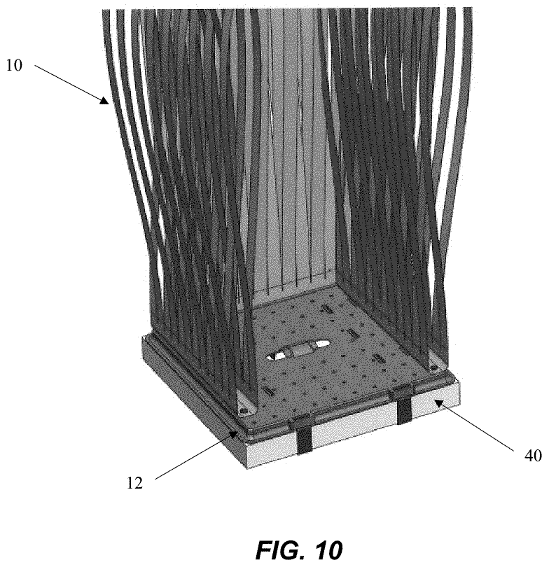

The weighted device 40 shown in FIG. 9B is sized to fit within the dimensions of the platform 12 and in between the indentations 30 on the bottom surface 32. As shown in this embodiment, the weighted device 40 may have a long dimension of approximately 7½-8 inches in length and a short dimension of approximately 3½-4 inches in width (which also approximates the distance between the indentations). However, the weighted device 40 may also be sized to match the size of the platform 12. As shown in FIG. 10, the perimeter of the platform 12 matches-up flush to the outside of the weighted device 40. In this embodiment, the outer edges of slots 28 sit flush with the outer edge of the weighted device 40.

While the weighted device 40 has been exemplified herein as being secured to the platform 12 with securing straps, the weighted device 40 may be secured to the platform 12 by other mechanisms. For instance, the bottom surface 32 of the platform 12 may be formed with clips or types of “legs” that are configured to secure the weighted device 40 to the platform 12. In this embodiment, the bottom surface 32 may include projections with a side flange that are flexible enough to expand to slide around the weighted device 40 and retain the weight with the side flange. In other embodiments, the bottom surface 32 of the platform 12 may include a compartment designed to receive and store the weighted device 40. The compartment may also be filled with a substance like gravel or sand to provide sufficient weight for the system 100 to sink. In other embodiments, a molded area may be formed in the upper surface 26 of the platform 12 where the weighted device 40 may be attached by snapping into place. In still other embodiments, the platform 12 may be formed such that it fits over the weighted device 40 and snapped or locked into place so that it is securely fastened to the weighted device 40.

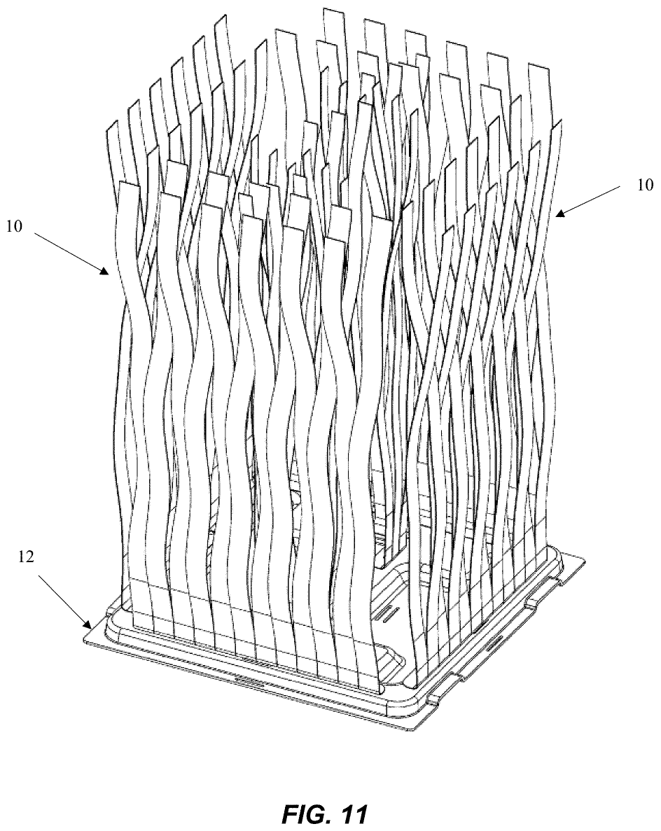

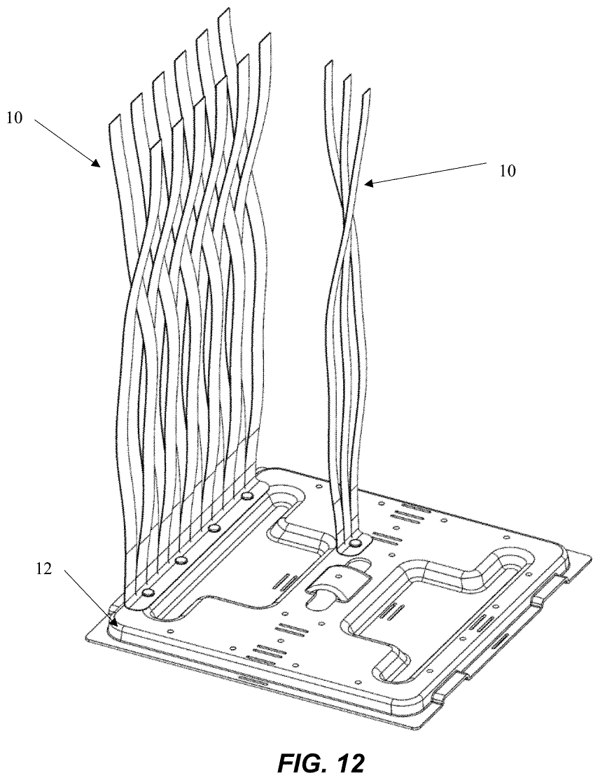

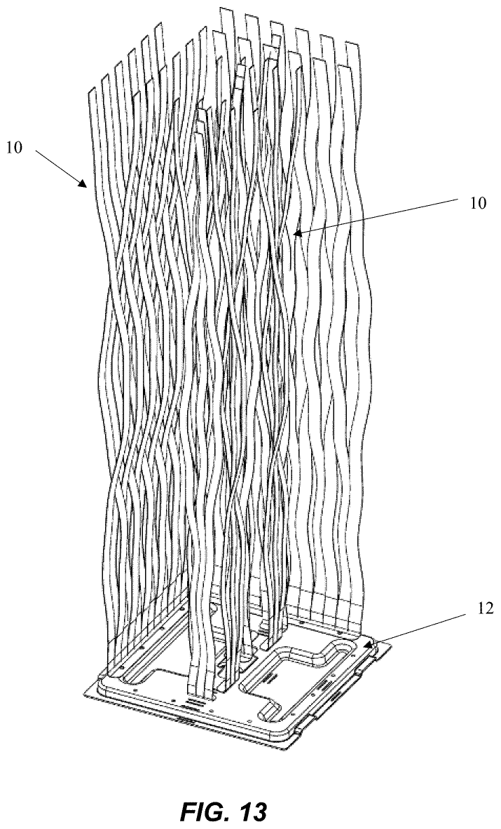

FIGS. 11, 12, and 13 show various combinations of artificial vegetation attachments 10 that can be used with the platform 12. In some embodiments, after the weighted device 40 has been secured to the platform 12, the artificial vegetation attachments 10 may be fastened to the platform 12. The fish attracting system 100 is customizable and different configurations of the artificial vegetation attachments 10 can be used depending on the aquatic environment in which the system 100 will be deployed and the desired visual effects. For example, as shown in FIG. 11, the platform 12 may be completely filled with the artificial vegetation attachments 10. The artificial vegetation attachments 10 may be fastened to the perimeter of the platform 12 and at interior locations. In another embodiment, as shown in FIG. 12, the artificial vegetation attachments 10 may only be attached along one edge of the platform 12 and/or at a single interior location, leaving large gaps in the middle of the platform 12 with no artificial vegetation attachments 10. In still another embodiment, as shown in FIG. 13, the artificial vegetation attachments 10 may be attached along more than one edge of the platform 12 (for example, along two or three edges) and/or at multiple interior locations.

Different lengths of the artificial vegetation attachments 10 can also be used. In some embodiments, artificial vegetation attachments 10 having a first length can be used in one location and other artificial vegetation attachments 10 having a second different length (for example, at least ½ the length, or at least ¼ of the length of the other attachments) can be used in other locations. For example, artificial vegetation attachments 10 that are approximately 4 feet high can be used along the perimeter of the platform 12, and artificial vegetation attachments 10 that are approximately 1 foot high, or approximately 2 feet high, can be used toward the center of the platform 12. As shown in the figures, various portions of the platform 12 may have no grass attachments at all.

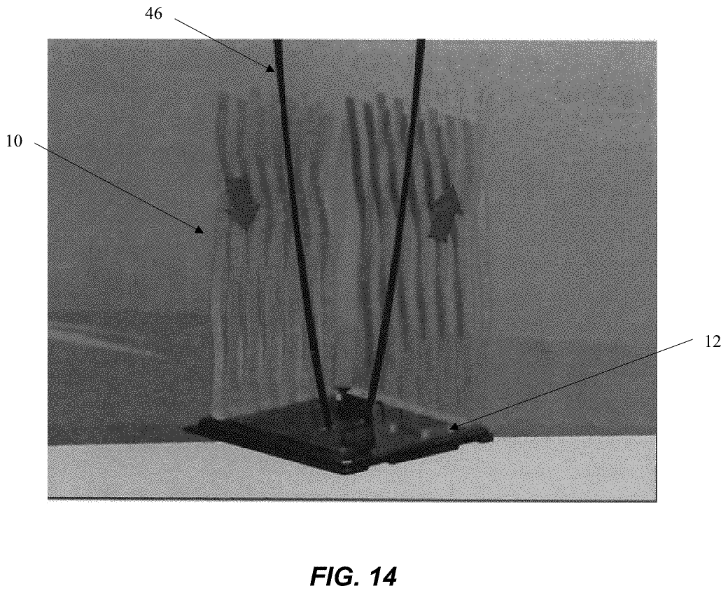

FIG. 14 shows the fish attracting system 100 deployed in a body of water after securing the weighted device 40 and installing the artificial vegetation attachments 10. The fish attracting system 100 can be lowered into the water using a rope 46, as illustrated in FIG. 14. The rope 46 may be attached at the anchor point 36 on the upper surface 26 of the platform 12 and can be pulled-through the opening 38 when lowered into the water. In other embodiments, the rope 46 can be tied to the center anchor point 36 and a floating marker or buoy (such as a duck decoy, lily pad, or bobber) can be attached so the fish attracting system 100 can be located from the surface. For example, twine may be used to mark the location of the system 100 when attached to the floating marker or buoy.

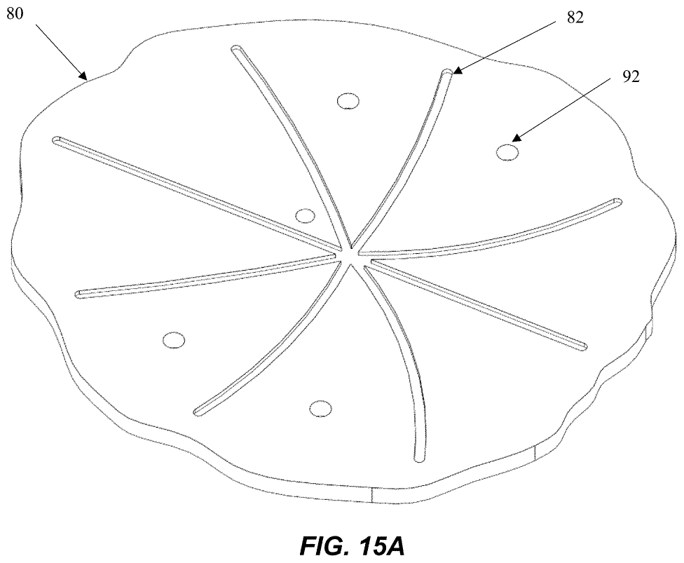

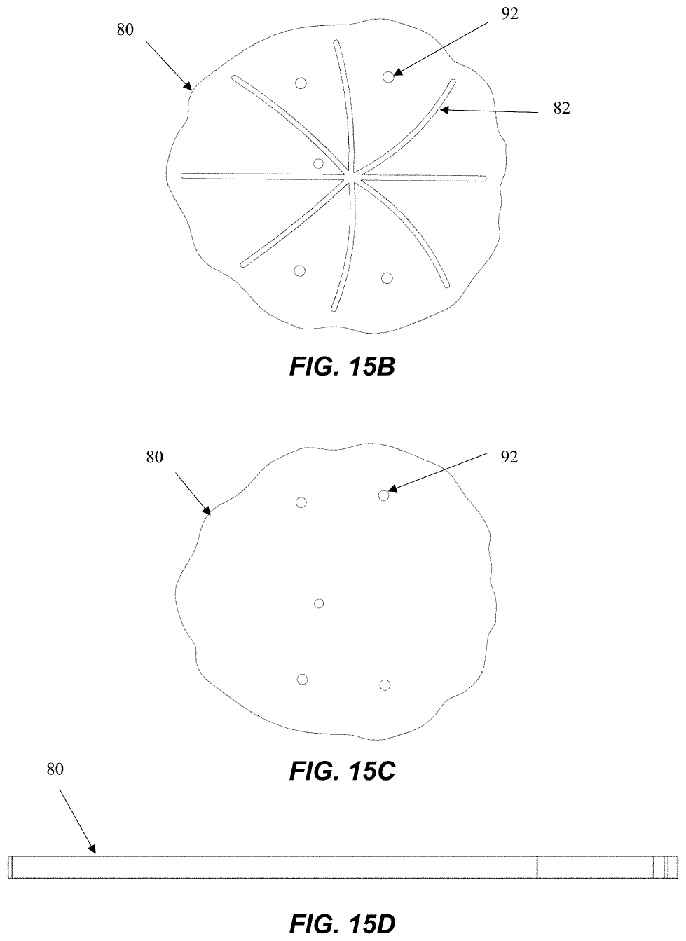

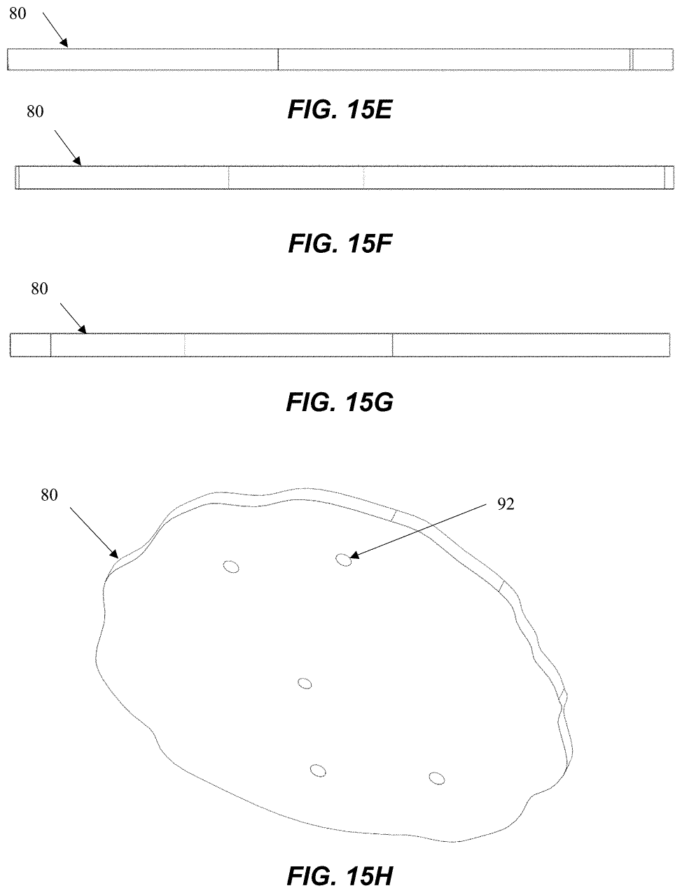

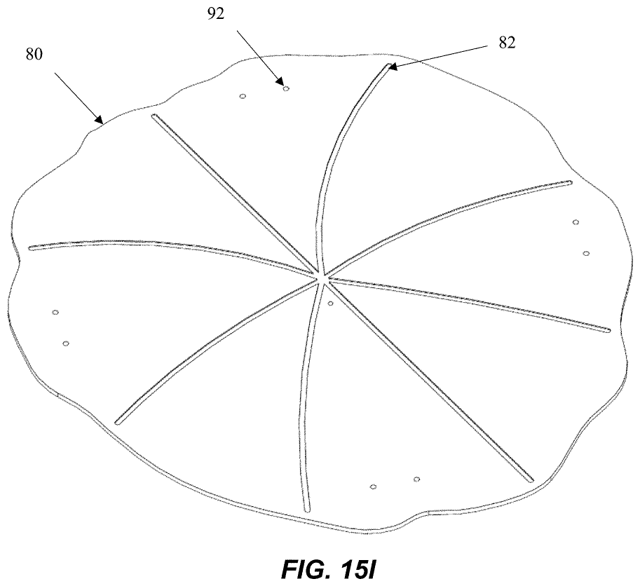

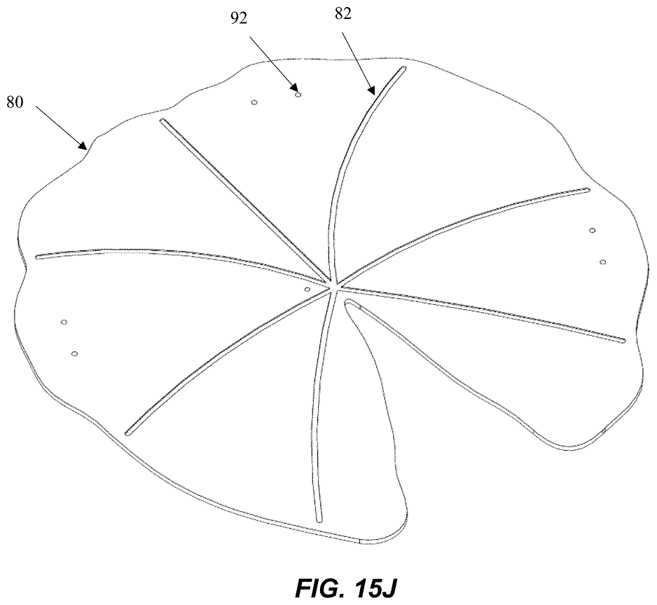

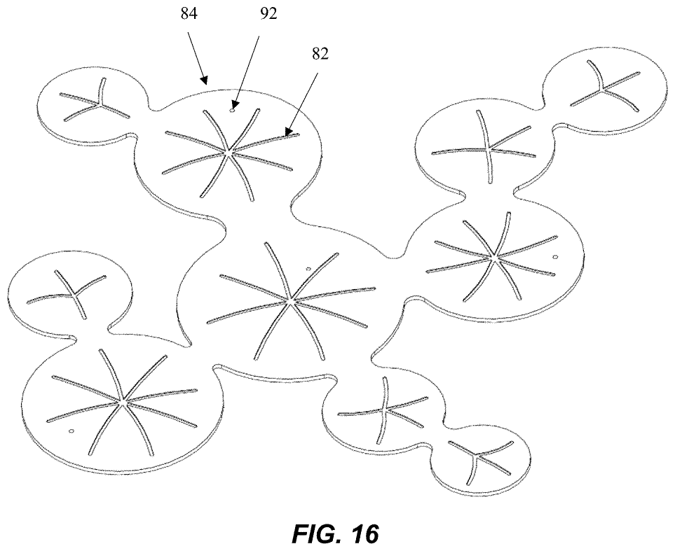

Referring now to FIGS. 15A-15J, 16, and 17, another general embodiment of a fish attracting system 200 is shown. FIGS. 15A-15I show artificial lily pads 80 according to one embodiment of the present disclosure that are designed to mimic one or more natural lily pads. The artificial lily pads 80 are designed to float on top of the water and are used to attract fish and enhance fishing. The artificial lily pads 80 may include markings 82 intended to mimic the spongy veins found in natural lily pads, but in other embodiments no veins are used. FIG. 15J shows the artificial lily pad 80 according to another embodiment of the present disclosure. The artificial lily pad 80 may include a “cutout” configuration. As shown in FIG. 15J, the artificial lily pad 80 includes a narrow V-shaped notch that extends from the leaf edge to the center near the stem. In some embodiments, the V-shaped notch is intended to mimic the natural shape of a lily pad.

FIG. 16 shows a cluster of artificial lily pads 80 according to an exemplary embodiment of the present disclosure. The cluster 80 is designed to mimic a cluster or group of natural lily pads. As illustrated in FIG. 16, the cluster 84 includes ten different artificial lily pads 80 attached together. The artificial lily pads 80 may be of varying sizes, as shown in FIG. 16. One or more of the artificial lily pads 80 in the cluster 84 may include the V-shaped notch discussed above and as shown in FIG. 15C. Any number of artificial lily pads 80 may be used to form the cluster 84. The artificial lily pads 80 and clusters 84 may also include a hole 92 so that other artificial lily pads or clusters, such as smaller lily pads, can be attached on top using a fastener to add more dimension to the artificial lily pads 80 and clusters 84.

The artificial lily pads 80 and the clusters 84 may be made from any suitable material that allows for the artificial lily pads 80 and the clusters 84 to be buoyant and float on the water. In one embodiment, the artificial lily pads 80 and the clusters 84 are made of polyvinyl chloride (PVC). For example, the artificial lily pads 80 and the clusters 84 may be made of closed-cell, rigid foam PVC. PVC is advantageous in that the material is eco-friendly, recyclable, and is free of toxic or harmful substances that can be given off over time, such as formaldehyde, asbestos, lindane, PCB, PCP, and CFCs. In other embodiments, the artificial lily pads 80 and the clusters 84 may be made from other polymeric materials including, for instance, nylon (polyamide), acrylic, polycarbonate, polyoxymethylene (POM), polystyrene (PS), acrylonitrile butadiene styrene (ABS), polypropylene (PP), high density polyethylene (HDPE), and polyethylene (PE). In some embodiments, the artificial lily pads 80 and the clusters 84 include a UV stabilizer, UV absorber, and/or UV inhibitor. UV absorbers are a type of light stabilizers that function by competing with chromophores to absorb UV radiation. UV stabilizers protect a surface through arresting the photo-degradation process. For example, hindered amine light stabilizers, or HALS, are a type of light stabilizer that may be used with the present disclosure. UV inhibitors protect against degradation from wavelength energy and oxidation caused by light. Any known UV stabilizer, absorber, or inhibitor may be used in accordance with the present disclosure.

In one embodiment, the artificial lily pads 80 and the clusters 84 have a density of less than 0.80 g/cm³. For example, the artificial lily pads 80 and the clusters 84 may have a density of about 0.60 g/cm³. The artificial lily pads 80 and the clusters 84 should also be weatherproof, weather resistant, and durable to withstand the aquatic environment. In some embodiments, the artificial lily pads 80 and the clusters 84 have a tensile strength greater than 10 MPa. In other embodiments, the artificial lily pads 80 and the clusters 84 have a tensile strength greater than 12 MPa. The artificial lily pads 80 and the clusters 84 may also have a coefficient of linear thermal expansion from −30° C. to 50° C. of less than or equal to 0.090 mm/mK, preferably less than or equal to 0.085 mm/mK. In some embodiments, the artificial lily pads 80 and the clusters 84 have low water absorption and low thermal conductivity.

In some embodiments, similar to the platform 12 described above with respect to the fish attracting system 100, the artificial lily pads 80 and the clusters 84 can be made from eco-friendly polymer materials with a rough texture or finish to promote the growth of algae, phytoplankton (micro-algae), and other bacteria, periphyton and other microorganisms that serve as a food source to fish and other living creatures. Optional materials that can be utilized for various aspects of the embodiments described herein, and some of the surface roughness ranges that may be utilized for those embodiments that utilize a rough texture, are set out in Table 1 below (where Ra is calculated as the Roughness average of a surfaces measured microscopic peaks and valleys):

TABLE 1
Surface Ra of Different Plastics
Surface Ra of different plastic

| | | Ra index arrange μm | | | | | | | | | | | |
|---|---|---|---|---|---|---|---|---|---|---|---|---|---|
| molding | material | 0.012 | 0.025 | 0.05 | 0.1 | 0.2 | 0.4 | 0.8 | 1.6 | 3.2 | 6.3 | 12.5 | 25 |

| | | | | | | | | | | | | | |
|---|---|---|---|---|---|---|---|---|---|---|---|---|---|
| inject | Thermoplastics | PMMA | 0.025 | 0.05 | 0.1 | 0.2 | 0.4 | 0.8 | 1.6 | | | | |
| | | ABS | 0.025 | 0.05 | 0.1 | 0.2 | 0.4 | 0.8 | 1.6 | | | | |
| | | AS | 0.025 | 0.05 | 0.1 | 0.2 | 0.4 | 0.8 | 1.6 | | | | |
| | | PC | | 0.05 | 0.1 | 0.2 | 0.4 | 0.8 | 1.6 | | | | |
| | | PS | | 0.05 | 0.1 | 0.2 | 0.4 | 0.8 | 1.6 | 3.2 | | | |
| | | PP | | | 0.1 | 0.2 | 0.4 | 0.8 | 1.6 | | | | |
| | | PA | | | 0.1 | 0.2 | 0.4 | 0.8 | 1.6 | | | | |
| | | PE | | | 0.1 | 0.2 | 0.4 | 0.8 | 1.6 | 3.2 | 6.3 | | |
| | | POM | | 0.05 | 0.1 | 0.2 | 0.4 | 0.8 | 1.6 | 3.2 | | | |
| | | PSU | | | | 0.2 | 0.4 | 0.8 | 1.6 | 3.2 | | | |
| | | PVC | | | | 0.2 | 0.4 | 0.8 | 1.6 | 3.2 | | | |
| | | PPO | | | | 0.2 | 0.4 | 0.8 | 1.6 | 3.2 | | | |
| | | Chlorinated | | | | 0.2 | 0.4 | 0.8 | 1.6 | 3.2 | | | |
| | | polyether | | | | | | | | | | | |
| | | PBT | | | | 0.2 | 0.4 | 0.8 | 1.6 | 3.2 | | | |
| | Thermosetting | Aminoplasts | | | | 0.2 | 0.4 | 0.8 | 1.6 | 3.2 | | | |
| | | phenolics | | | | 0.2 | 0.4 | 0.8 | 1.6 | 3.2 | | | |
| | | Silicone plastic | | | | 0.2 | 0.4 | 0.8 | 1.6 | 3.2 | | | |
| press | | Aminoplasts | | | | 0.2 | 0.4 | 0.8 | 1.6 | 3.2 | | | |
| | | phenolics | | | | 0.2 | 0.4 | 0.8 | 1.6 | 3.2 | | | |
| | | Melamine | | | 0.1 | 0.2 | 0.4 | 0.8 | | | | | |
| | | Silicone plastic | | | | 0.2 | 0.4 | 0.8 | | | | | |
| | | DAP | | | | | 0.4 | 0.8 | 1.6 | 3.2 | | | |
| | | Unsaturated | | | | | 0.4 | 0.8 | 1.6 | 3.2 | | | |
| | | polyester | | | | | | | | | | | |
| | | Epoxy plastic | | | | 0.2 | 0.4 | 0.8 | 1.6 | 3.2 | | | |
| | | Plexiglass | 0.025 | 0.05 | 0.1 | 0.2 | 0.4 | 0.8 | 1.6 | 3.2 | 6.3 | | |
| | | PA | | | | | | | 1.6 | 3.2 | 6.3 | 12.5 | |
| | | PTFE | | | | | | 0.8 | 1.6 | 3.2 | 6.3 | 12.5 | |
| | | PVC | | | | | | | 1.6 | 3.2 | 6.3 | 12.5 | |
| | | Reinforced | | | | | | | 1.6 | 3.2 | 6.3 | 12.5 | 25 |
| | | plastics | | | | | | | | | | | |

The size, color, and shape of the artificial lily pads 80 can vary, but in some embodiments, the artificial lily pads 80 are green and include generally round or oval shapes. The artificial lily pads 80 may have a round shape with approximate diameters ranging from 10 inches to about 70 inches. For example, the artificial lily pads 80 may have approximate diameters of 15 inches, 20 inches, 24 inches, 48 inches, or 60 inches. In other embodiments, the artificial lily pads 80 may have a generally oval shape with approximate dimensions of about 32 inches by 33 inches. In still other embodiments, the lily pad clusters 84 may have an overall length ranging from about 30 inches to about 70 inches, preferably about 32 inches to about 60 inches, more preferably about 40 inches to about 48 inches, and an overall width ranging from about 35 inches to about 45 inches, preferably about 38 inches to about 40 inches. The thickness of the artificial lily pads 80 and the clusters 84 can vary, for example, between ⅛ inch and 1 inch, preferably between ¼ of an inch and % of an inch, and more preferably between approximately ¼ of an inch and ½ of an inch. For example, the artificial lily pads 80 and the clusters 84 may have a thickness of about ¼ of an inch.

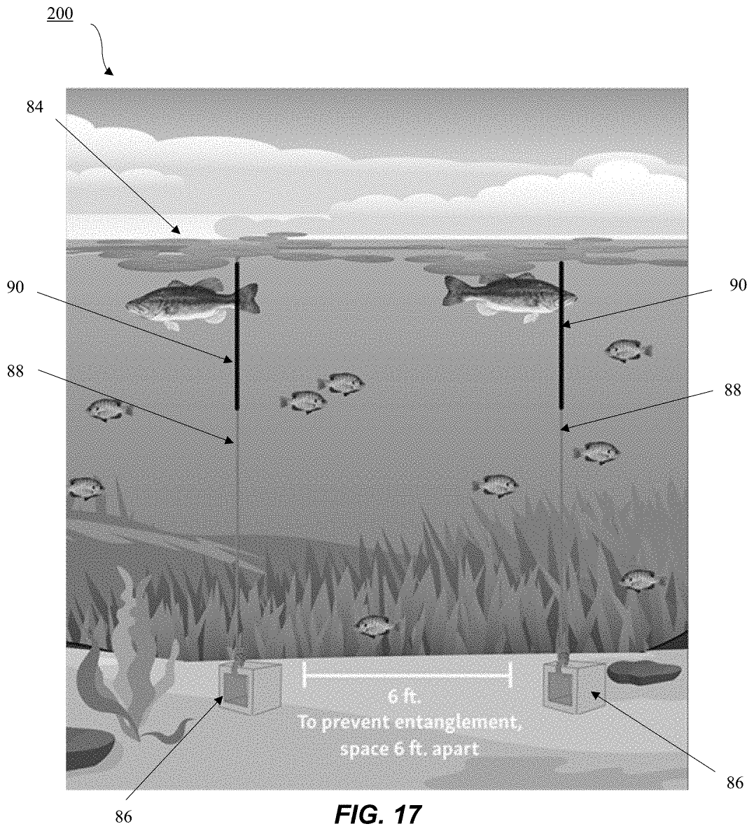

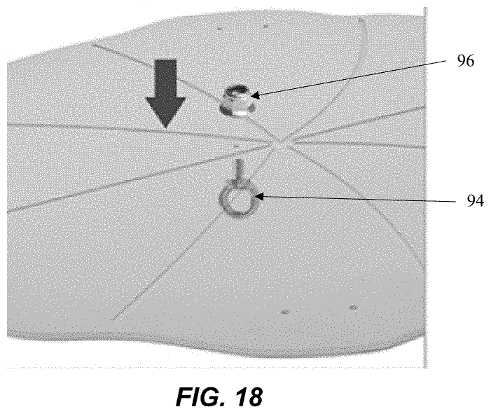

FIG. 17 shows the artificial lily pads 80 and the clusters 84 placed in the aquatic environment. The artificial lily pads 80 and the clusters 84 can be attached to a weight 86 secured to the bottom of a body of water. In some embodiments, an eyebolt 94 and nut 96, shown in FIG. 18, placed near the center of the artificial lily pad 80 or main portion of the cluster 84 can be operatively connected to an expandable marine bungee cord 88 that is attached to the weight 86. The bungee cord 88 may be operatively connected, for example, tied, to the eyebolt 94. The bungee cord 88 may include a snag protector 90 that floats directly under the artificial lily pads 80 or the clusters 84 to prevent lure snags. The artificial lily pads 80 and the clusters 84 can be deployed onto the water surface and anchored to the bottom by the weight 86. The embodiment shown in FIG. 17 also allows the artificial lily pads 80 and the clusters 84 to fluctuate due to water level changes. If more than one artificial lily pad 80 or cluster 84 are being utilized in close proximity to each other, each artificial lily pad 80 or cluster 84 should be spaced at least six feet apart to prevent entanglement.

This invention may be provided in other specific forms and embodiments without departing from the essential characteristics as described herein. The embodiments described are to be considered in all aspects as illustrative only and not restrictive in any manner. The invention is not limited to the particular embodiments of the invention that have been described, since modifications may be made by those skilled in the art, particularly in light of the foregoing teachings.

What is claimed is:

1. A fish attracting system, comprising:
a platform having a surface with a first hole formed therein,
an artificial vegetation attachment comprising a base and a plurality of vegetation strands attached to the base, wherein the base comprises a second hole corresponding to the first hole and configured for receiving a fastener to secure the artificial vegetation attachment to the platform, and
wherein the vegetation strands are formed of polyethylene film.

2. The fish attracting system of claim 1, wherein the base has a width of about ¼ inch to about 3 inches.

3. The fish attracting system of claim 1, wherein the vegetation strands have a specific gravity of about 0.88 to about 0.92.

4. The fish attracting system of claim 1, wherein the vegetation strands have a width ranging from about 5 inches to about 36 inches and a length ranging from about 1 foot to about 8 feet.

5. The fish attracting system of claim 1, wherein the vegetation strands have a thickness of about 0.01 inches to about 0.07 inches.

6. The fish attracting system of claim 1, wherein the platform is formed of acrylonitrile butadiene styrene (ABS).

7. The fish attracting system of claim 1, wherein the platform has a specific gravity of greater than 1.0.

8. A fish attracting system, comprising:
a platform having a surface with a first hole formed along a perimeter of the platform and a second hole formed on an interior portion of the platform,
a first artificial vegetation attachment comprising a first plurality of vegetation strands,
a second artificial vegetation attachment comprising a second plurality of vegetation strands,
wherein the first plurality of vegetation strands comprises a greater number of vegetation strands than the second plurality of vegetation strands and the first plurality is configured for attachment at the first hole and the second plurality is configured for attachment at the second hole.

9. The fish attracting system of claim 8, wherein the first plurality comprises at least ten vegetation strands.

10. The fish attracting system of claim 8, wherein the second plurality comprises at least two vegetation strands.

11. The fish attracting system of claim 8, wherein the surface of the platform has a textured finish.

12. The fish attracting system of claim 8, wherein the platform is shaped as a square and comprises a length and a width ranging from about 8 inches to about 30 inches.

13. The fish attracting system of claim 8, wherein the platform has a height of about 0.5 inches to about 2 inches.

14. The fish attracting system of claim 8, wherein the platform comprises a plurality of slots formed within the surface configured for receiving a securing strap.

15. A kit for a fish attracting system, comprising:
a platform having a surface comprising a plurality of holes configured for receiving a fastener and a plurality of slots for receiving a securing strap,
an artificial vegetation attachment configured for attachment to the platform, wherein the artificial vegetation attachment comprises a base and a plurality of vegetation strands integrally formed with the base,
a plurality of fasteners configured for attaching the base of the artificial vegetation attachment to the platform, and
a plurality of securing straps configured for attaching a weight to the platform.

16. The kit of claim 15, wherein the weight comprises a cinder block or a paver.

17. The kit of claim 15, wherein the fasteners comprise friction fit pins or push pins.

18. The kit of claim 15, further comprising a rope configured for attachment to the platform and for lowering the fish attracting system into a body of water.

19. The kit of claim 15, wherein the securing straps are hook and loop fasteners.

20. The kit of claim 15, further comprising a buoy marker, buoy twine, or both.
